(19) United States
(12) Patent Application Publication
(10) Pub. No.: US 2006/0186749 A1
(43) Pub. Date: Aug. 24, 2006

(54) Motor

(76) Inventor: Johannes Matthys Strydom, Zwavelpoort (ZA)

Correspondence Address: Ralph A. Dowell of DOWELL & DOWELL P.C., 2111 Eisenhower Ave, Suite 406, Alexandria, VA, 22314, US

(21) Appl. No.: 10/537,347

(22) PCT Filed: Dec. 4, 2003
(86) PCT No.: PCT/IB03/05626

§ 371 Date: Oct. 12, 2005

(30) Foreign Application Priority Data
Dec. 5, 2002 (ZA) 2002/9881

(51) Int. Cl. H02K 49/00

(52) U.S. Cl. 310/103

(57) ABSTRACT

A motor includes a stator and a rotor in the form of a disc which is connected to an axis about which it is able to rotate. The rotor has a plurality of permanent magnets connected around the outer perimeter of the disc which are of alternating polarities. A plurality of electromagnets are connected around the inner perimeter of the stator. When current is applied to the electromagnets, the permanent magnets on the disc will attempt to align their poles with the opposing pole of the magnets on the stator. As this is accomplished, the current is reversed thereby reversing the poles of the electromagnets. Thus, the initial attracting force is changed into a repelling force which moves the disc further in the same direction.

### BACKGROUND OF THE INVENTION

THIS invention relates to an improved motor.

### SUMMARY OF THE INVENTION

According to the present invention there is provided a motor comprising:
a first housing having a radius which is greater than the width of the housing;
a second housing having an opening therein in which the first housing is at least partially located, wherein either of the first or second housings is able to rotate with respect to the other housing; and
a plurality of magnets located around a perimeter of either the first or the second housing, wherein the magnetic force of magnets causes the one housing to rotate with respect to the other housing.

The motor may further include a plurality of magnets located around a perimeter of the other of the first or second housing.

The magnets located on the first housing may be of alternating polarities.

The magnets located on the second housing may also be of alternating polarities.

Alternatively, the magnets located on the first housing may be of the same polarity and the magnets located on the second housing may be of the same polarity.

The first housing has a ratio of the radius to width ratio of at least 2:1.

Preferably, the ratio of the radius to width ratio is at least 8:1.

The angle of the forces acting between adjacent ones of the magnets on the first housing and the magnets on the second housing does not exceed 25 degrees.

In one application, the first housing is able to move with respect to the second and housing and wherein the interior of the first housing is formed into a plurality of propeller blades.

The plurality of magnets on the first and second housings may be permanent magnets or electromagnets.

Preferably, all of the magnets are energized simultaneously when the motor is in use.

Also, both poles of the magnets on either the first or second housing may act simultaneously on the magnets of the other housing.

In one instance, an induction force is applied on both surfaces of the first housing, perpendicular to an axis of the housing.

According to the present invention there is further provided a motor comprising:
a first housing connected to an axis about which it is able to rotate;
a second housing having an opening therein;
a plurality of magnets connected around a perimeter of the first housing, wherein the plurality of magnets are of alternating polarities, wherein when the first housing connected to the axis rotates, the plurality of magnets pass sequentially through the opening in the second housing; and
a plurality of magnets connected to the second housing on either side of the opening.

### BRIEF DESCRIPTION OF THE DRAWING

FIG. 1 is a schematic illustration of the motor of the present invention;

FIG. 2 is a schematic illustration showing the forces acting in a conventional motor;

FIG. 3 is a schematic illustration showing the forces acting in the motor of the present invention;

FIG. 4 is a cross section through a second embodiment of the present invention;

FIG. 5 is a cross section through a another example of the second embodiment of the present invention; and

FIG. 6 illustrates an exemplary application for the present invention.

### DESCRIPTION OF EMBODIMENTS

Referring to the accompanying drawing, a motor 10 includes an outer housing 12 and an inner housing 14. In the illustrated embodiment, the inner housing 14 has a radius greater than the width of the housing and is in the form of a disc which is connected to an axis 16 about which it is able to rotate.

The outer housing 12 in the illustration will be held stationery in use while the inner housing will form the rotor. However, it will be appreciated that this relationship could be reversed with the outer housing being rotatable about the inner housing which is held stationery in use.

The inner housing 14 has a plurality of permanent magnets 18 connected around the outer perimeter of the disc 14. The plurality of permanent magnets 18 are of alternating polarities, as indicated in the illustration.

A plurality of electromagnets 20 are connected around the inner perimeter of the housing 12.

In principle, the present invention uses a large, thin rotor with many magnets arranged dose to each other along the outer perimeter of the rotor. The rotor has a large circumference compared to its width along the axis, thereby giving a relatively large diameter. The rotor of other electric motors typically have a small circumference compared to their height along the axis, giving a relatively small diameter.

Whereas traditional electric motors typically have two or three large electromagnets tightly fitted around the axis (some stepper motors may have more magnets), the present invention uses many magnets fitted some distance from the axis of a circle thereby giving the advantage of leverage. The magnets are situated close to each other, and the larger the radius, the more magnets are used.

The rotor would normally be constructed from aluminum, but many different materials could be used.

Although the illustrated embodiment has the permanent magnets located on the inner disc and the electromagnets located on the outer housing, this configuration can be changed if convenient. For example, the permanent magnets can be located on the outer housing and the electromagnets located on the inner disc, or both could have permanent magnets or electromagnets.

Alternatively, one of the housings could have magnets thereon and the other could have no magnets thereon and be driven by the flux from the other housing. In this regard, Aluminium is a paramagnetic material. This means that it becomes magnetic in the presence of an electromagnetic field. By setting up a rotating magnetic field around the perimeter of the stator, a magnetic force is induced on the rotor which turns it in a specific direction. This would be applied when using the motor as an induction motor.

Some induction motors have windings in the rotor, whilst most just link the aluminium segments with copper short-circuits because it can handle larger currents, and therefore have a larger induction force. Some linear induction motors (LIMs) use ladder-like aluminium rails to pick up the induction forces, whilst most supplement it with iron backing plates and/or reaction plates.

The Lorentz force is a force with a direction perpendicular to both the direction of electric current, and the direction of the magnetic flux according to the right-hand rule. This force can be utilized by aligning the motion of the rotor with the direction of the Lorentz force.

Another option is to arrange the magnets on the rotor, not with alternating polarities, but with aligned polarities. All the north poles would point in the same direction, and the south poles would also point in the same direction (opposite to the direction of the north poles)

This would normally be done where the Lorentz force is to be used in conjunction with the magnetic force of the magnets.

The reason for this is that the direction of the Lorentz force is determined by the direction of the current, as well as the direction of the magnetic flux (which, in turn, determines to polarities of the magnets). So, in order to get the Lorentz force working in the same direction around the rotor, the poles of the electromagnets will have to be aligned in this case.

Although there are some electric motors where the diameter of the rotor is slightly larger than its height, the difference is not nearly as emphasized as in the new design.

Pure induction (without permanent magnets), described above, is normally used in cases where overheating of magnets causes a problem, or simply because its easier and cheaper to construct and maintain.

It must be noted, however, that induction motors apply the induction force on the side of the rotor (parallel to the axis), whereas here is applied on both surfaces of the rotor perpendicular to the axis.

The result is that with the new design, the induction force is applied on a much larger surface area of the rotor. Because the strength of induction force is a factor of the area to which it is applied, the torque on the rotor is vastly increased with this new design.

It is also unique to apply induction force in conjunction with permanent magnetic force.

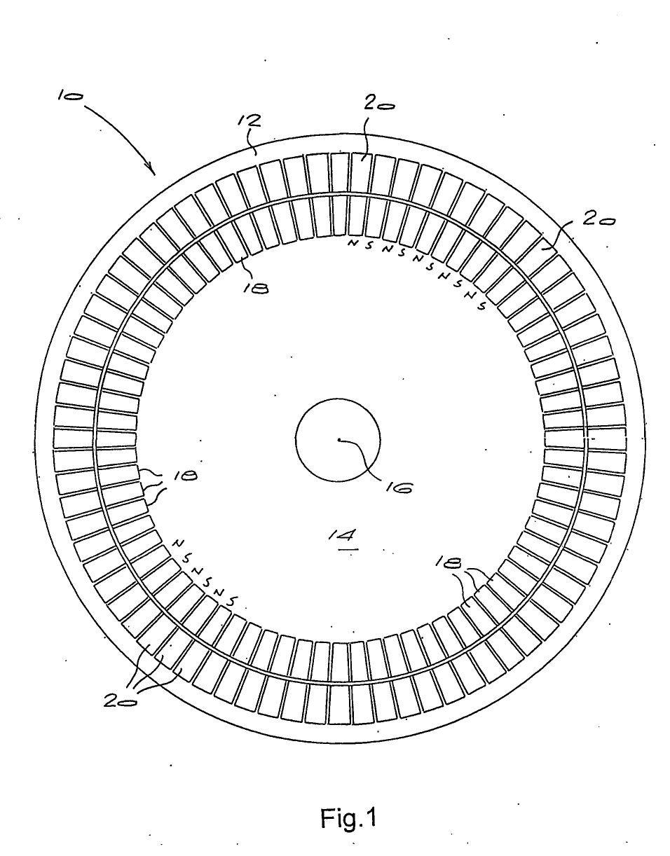

In any event, referring back to FIG. 1, the electromagnets 20 are supplied with electricity from either an AC or DC power source which is not shown in the accompanying FIG. 1.

When current is applied to the electromagnets 20, the permanent magnets 18 on the disc will attempt to align their poles with the opposing pole of the magnets 20 on the housing 12.

As this is accomplished, the current is reversed thereby reversing the poles of the electromagnets 20.

Because the poles of the electromagnets 20 are now reversed, and because the disc 14 is moving, the north pole of the permanent magnets 18 will pass the point where they align with the north poles of the opposite electromagnets 20 and vice versa. Thus, the initial attracting force is changed into a repelling force which moves the disc further in the same direction.

In other words, just before north and south poles align with each other, the electromagnets 20 are de-energised and the momentum of the rotor carries the poles of the permanent magnets 18 past the point at which they align with the poles of the electromagnets 20. At this point, the electromagnets 20 are energised in the opposite direction, so that the poles now just beyond the point at which they were aligned are now similar, and thus repel each other, creating increased angular momentum on the rotor in the same direction. At the same time that the similar poles are repelling each other, the opposing poles attract each other, creating an increased angular momentum on the rotor in the same direction, further increasing the torque and acceleration of the rotor in the same direction.

Thus it will be appreciated that the magnets diagonally opposite each electromagnet simultaneously attract or repel each magnet.

It will also be appreciated that both attracting and repelling forces work in harmony to rotate the disc 14.

The switching mechanism for switching the polarity of the electromagnets 20 could be a number of switching mechanisms. For example, the switching mechanism could be a commutator or be implemented by simply supplying an AC power supply to the electromagnets 20.

Another way of implementing the switching mechanism is to use infrared optical sensors.

An optical sensor is needed at each point where the polarity of the electromagnets is switched, so the same number of sensors as electromagnets is required.

However, only two receptors are needed. The reason for this is because there are basically two groups of electromagnets (looking at their polarity) and each sensor switches on a whole group at a time. Unevenly numbered electromagnets (1,3,5,etc.) form one group, while evenly numbered electromagnets (2,4,6,etc.) form the other group.

The sensors are positioned on the housing 12 while the receptors are positioned on the disc 14.

Because there are two receptors, at any given time, two optical sensors would be activated. One sensor would power group one of electromagnets, while the other would power group two.

With each alternating sensor, the positive and negative terminals are reversed. It is thus connected to the power source in the opposite way to its predecessor. So, if terminal one of the first optical sensor is connected to the positive terminal of the power source, terminal one of the second sensor would be connected to the negative terminal of the power source, and so on.

Thus two circuits are implemented, each powering a group of electromagnets, and each switched on and off by the optical sensors.

In order to use a commutator as a switching mechanism a smaller disc (the commutator), is fitted around the axis. The commutator therefore turns with the disc, and for all practical purpose is part of the disc, except that it is slightly elevated. This is needed for the bushes. The commutator must have a contact point for each electromagnet. Each contact point on the commutator must also be in line with its corresponding electromagnet.

Each contact point on the commutator is wired to the electromagnets in such a way that the polarity of each alternating electromagnet is reversed. If the first electromagnet is wired from top to bottom, then the second is wired from bottom to top, etc. Or put another way, if the north pole of electromagnet 1 is on the outer perimeter of the disc, then the south pole of electromagnet 2 must be on the outer perimeter of the disc, and so on. Contact two on the commutator will simply reverse this.

On opposing sides of the commutator, a bush is fitted. The bush is not fitted onto the disc, but secured from the housing, so that the bushes do not turn with the disc. The bushes remains stationary as the disc turns, but makes contact with different contacts on the commutator, each time reversing the direction of the current.

Bush one is connected to the positive terminal of the power source, and bush two is connected to the negative terminal of the power source.

It will be appreciated that these are only two examples of switching mechanisms. Regardless of which switching mechanism is used, the large radius and small width along the rotor axis as explained above becomes very significant when one takes a close look at leverage.

Leverage determines torque. Torque (in newton metre NM) is the force applied (newtons N) times distance of lever (in metres M). Therefore torque (NM)=newton×metre.

If the force is applied on the outer perimeter of the rotor of the present invention, the size of the lever is the radius of the rotor.

In a normal electric motor, the torque is increased by increasing the force, whereas in the present invention, torque is increased by increasing the lever. The difference is that it costs energy to increase the force whereas increasing the lever does not consume energy. It is therefore more energy efficient to increase the lever than the force applied on it.

To quantify this concept, in the present invention, the length of the lever would normally exceed the width of the rotor by a factor of about 8:1. However, because one would hardly ever find a rotor where the lever exceeds the width of the rotor, even a rotor having a radius to rotor width ratio of more than 2:1 or more than 3:1 would provide significant advantages.

Furthermore, in the present invention, all electromagnets are energised simultaneously when torque and acceleration is needed. This dramatically increases the torque and acceleration of the motor because all levers are applied simultaneously.

Unlike normal electric motors where brute force is used to obtain the desired result, with this new design, the laws of physics are combined with focused energy to obtain the desired results.

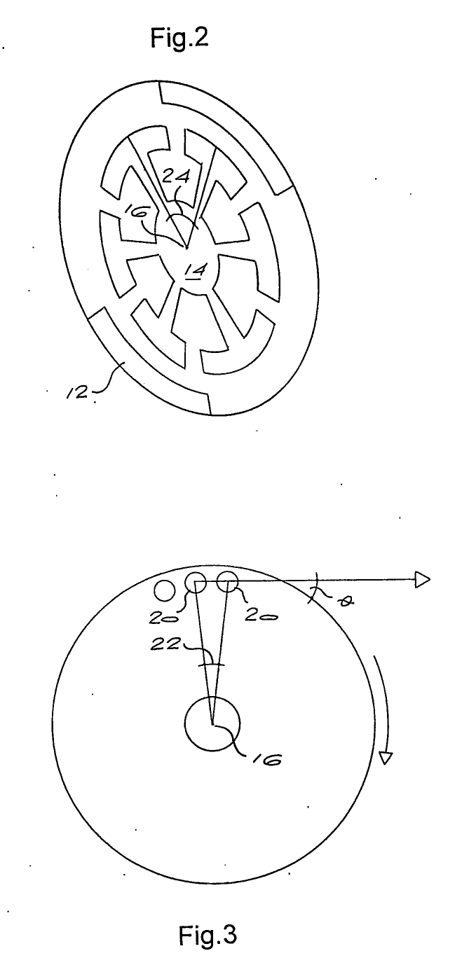

Referring to FIGS. 2 and 3, another advantage of the present invention is that the angle 22 on the axis 16 between forces acting on each other is small, as can be seen in FIG. 3. This is because all electromagnets 20 are energised simultaneously and so the angle 22 will never exceed 360 degrees divided by the number of electromagnets 20 around the perimeter of the rotor.

It is envisaged that with a motor of the present invention, this angle 22 on the axis between forces acting upon each will not exceed 25 degrees.

As can be seen in FIG. 2, with normal electric motors, the angle 24 varies substantially due to the fact that all electromagnets are not energised simultaneously, and fewer magnets are being used.

The effect of this small angle on the rotor is that the smaller this angle on the axis, the smaller the difference between the direction of forces acting upon each other and direction of momentum of the rotor.

This angle θ is the angle between the direction of momentum of the rotor and the direction of force of the electromagnets. The smaller this angle, the more efficiently the force is applied.

With other electric motors this angle varies and sometimes becomes severely large.

The following factors reduce this angle:
The larger the diameter of the rotor, the closer the circumference becomes to a straight line, reducing the angle.
The more magnets placed around the outer perimeter of the rotor, the smaller the angle.
The closer the centre points of the poles of the magnets on the rotor and stator are in relation to each other, the smaller the angle.
The more magnets energised simultaneously, the smaller the angle.

The present invention takes all of the above points into account, thus reducing the angle more than other electric motors.

The present invention thus utilizes a combination of linear propulsion and leverage.

It will also be appreciated that the present invention uses both poles of each of the electromagnet and/or permanent magnet to exert a force on the rotor. Standard electric motors do not utilize both poles of all magnets in applying a force on the rotor.

Also, magnetic force dissipates drastically over distance and with the present invention, the distance between magnetic forces acting on each other is reduced by reducing the size of the individual magnets, increasing the number of magnets, and increasing the circumference of the rotor.

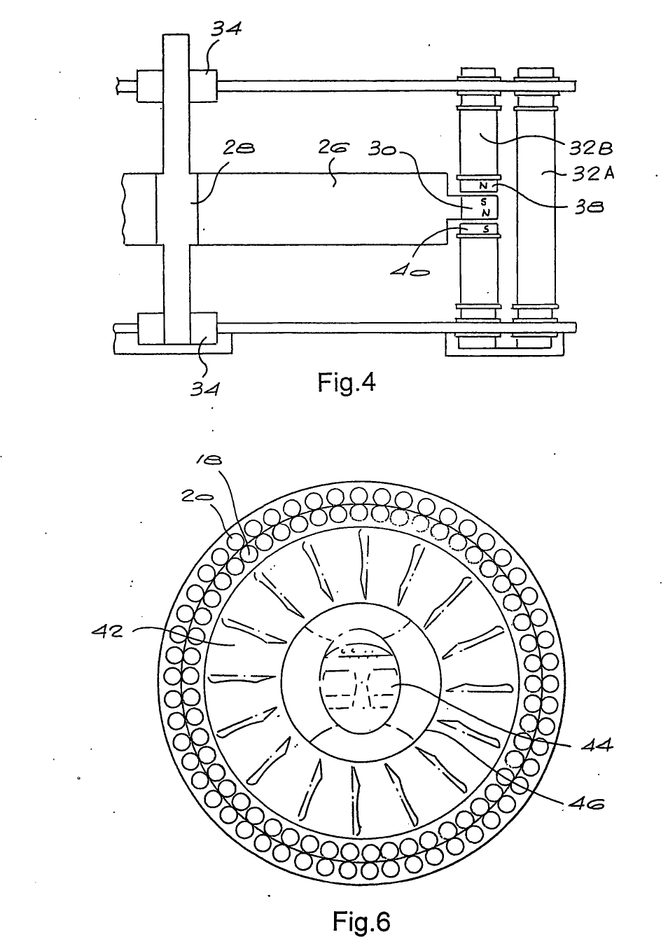

Referring to FIG. 4, a rotor 26 is arranged to rotate about a central support plate 28. At the end of the rotor 26 is a permanent magnet 30 having north and south poles as illustrated in the Figure. It will be appreciated that because the Figure is a cross section, there are a plurality of magnets 30 arranged around the perimeter of the rotor 26 where each of these magnets have alternating polarities in relation to the magnet next to it.

The central support plate 28 is able to rotate by means of bearings 34.

A stator 32 has a long coil 32A and a short coil 32B. The long coil 32A and the short coil 32B need to be connected to one another and one method of accomplishing this is to use a soft iron bridge. If the support plates are made of soft iron they could be used as the connector however it is preferable to insert a soft iron bridge above and below the coils 32A and 32B thereby joining them together. In any event, the stator 32 is arranged with an opening therein through which a portion of the rotor 26 can pass. On either side of the opening are electromagnets 38 and 40.

In a manner similar to as has been described above with reference to the first embodiment, when the rotor 26 rotates, the electromagnets 38 and 40 will alternate polarity thereby attracting and repulsing the magnets 30 on the rotor 26 in order to get the rotor to turn.

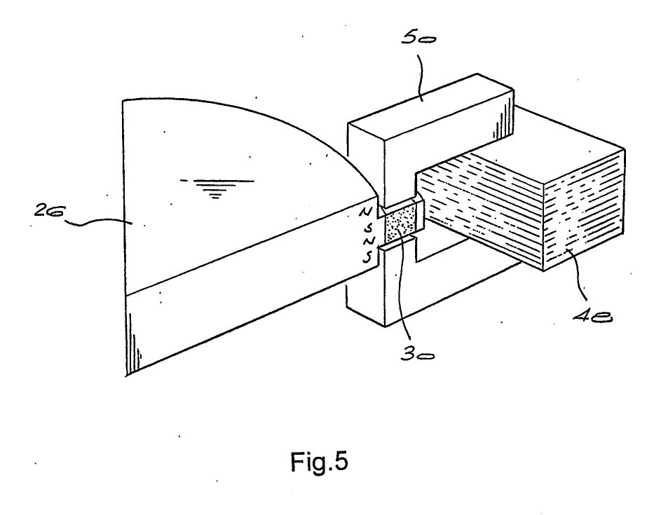

Referring to FIG. 5, in an alternative embodiment, the motor of FIG. 4 could be implemented with the stator being a laminated C-core arrangement. The stator of the motor has windings 48 of an electromagnet which are connected to a laminated core 50 which has an opening therein. As with the embodiment in FIG. 4, a plurality of permanent magnets on the rotor 26 are arranged with alternating polarities to pass through the opening in the stator.

As with the embodiment illustrated in FIG. 1, it will be appreciated that the magnets in either of the embodiments illustrated in FIGS. 4 and 5 could be swapped in that the magnets on the rotor 26 may be electromagnets or permanent magnets, as could the magnets on the stator 32 be either electromagnets or permanent magnets. Alternatively, both discs could have electromagnets or one of the discs could have magnets thereon and the other disc could have no magnets thereon and be driven by the flux from the other disc.

The aim of this embodiment is to reduce the flow path of magnetic flux in the circuit. Magnetic flux always flows in a complete circuit. It flows from the north pole of the electromagnet to the closest south pole, following the shortest path through core material with the highest permeability available to it. Where no core material is available, it will complete the path through air.

Air has the lowest permeability of all materials, and severely restricts the strength of the electromagnet. The aim is therefore to reduce the air gap to as small as possible, whilst still remaining useful.

The embodiment described with reference to FIG. 4 addresses this by allowing the rotor housing the permanent magnets to cut through a section of the stator housing the electromagnets, thereby completing the magnetic flux circuit whilst simultaneously reducing the air gap to as small as possible.

Also, the poles are alternated to allow the flux to flow from north to south to north to south at the intersection.

Both embodiments of the present invention have numerous applications.

Apart from situations where an electric motor has to be either very compact or cheap, the motor of the present invention could be used in numerous applications. It is ideal as a new power source for motor vehicles, aircraft, ships, hover crafts, computer drives, extractor fans and power generators to name but a few examples of the large number of applications of the motor of the present invention.

As a power source for motor vehicles, the motor, due to the high revolutions obtainable, low friction and heat, and high torque makes many components of a traditional vehicle, like gearbox and clutch unnecessary.

It also makes the manufacture of efficient and economical personal flying vehicles feasible.

In motor vehicles, when applying brakes, or going downhill, the motor could be used as a generator to charge the batteries.

Instead of normal electromagnets, superconducting electromagnets could be used, which means that once going, the motor would not require further energy. This is especially applicable to aircraft and generators.

This will make personal power sources with little pollution possible.

For larger applications, such as motor vehicle engines, air transport vehicles or large power generators, it could be desirable to have multiple rotors. These rotors are then stacked on top of each other on the same axis.

It will also be appreciated that the working of a generator is basically similar to that of a motor, except that instead of converting electric energy to mechanical energy, it converts mechanical energy to electric energy.

Because a generator is so similar to a motor the present invention could be used to implement a generator or alternator.

As generators, the motor could be used as turbines very effectively, especially with superconducting electromagnets.

One particular application relates to the use of a motor with propeller blades where the propeller blades are formed as part of the rotor.

A normal motor with propeller blades, like an electric fan, aircraft turbine, extractor fan, etc. has the motor in the middle of the blades tightly around the axis. The major problems with this arrangement are that:
Firstly, the laws of leverage are working against the motor because the force is applied on a short lever whilst the resistance is applied on a long lever.
Secondly, the air wants to flow through the middle, but finds itself blocked by a bulky engine.
Thirdly, the propeller blades can be a great danger if unprotected as is the case of helicopter blades, and there can be disastrous results if they touch anything in mid-flight.
Further, when applied to wind turbines, generators or alternators, the difference between having the flux on the inside or the outside of the propeller blades is severe when one looks at the electric current generating potential. The current generated increases with the speed at which the flux is cut as well as the surface area of flux being cut. The speed with which flux is cut is vastly greater with the new design for the same revolutions per minute, because a larger radius causes a larger circumference and thus a longer distance covered in the same time-frame.

Referring to FIG. 6, the propeller blades 42 are arranged inside the rotor. A cabin 44 is connected to the rotor by a bearing 46. This leads to a number of advantages:
Firstly, the force is applied on the longest lever outside the outer edge of the propeller
Secondly, aircraft turbines and extractor fans could have a hole in the middle, allowing for unrestricted airflow or drastically increased airflow depending on the application. For example, in these cases, an axis would not be necessary as no load needs to be placed on it.
Thirdly, with the illustrated design the rotor and thus the propeller blades are surrounded and protected by the stator. It is easy to surround the stator with a rubber bumper for even more protection. Helicopters equipped with such motorised blades may be able to collide against each other or other obstacles in mid-flight without crashing.
Because there is more space available on the outside of the propeller blades than on the inside, more magnets can be fitted there, and therefore a larger area of magnetic flux can be cut.

In a similar manner, the motor could form the wheels of a motor vehicle where the rotor is on the outside and the stator is on the inside. Thus, each wheel would be a separate motor.

1.-15. (canceled)

16. A motor comprising:
a first housing having a radius which is greater than the width of the housing and having a plurality of magnets located thereon; and
a second housing having an opening therein in which the first housing is at least partially located and having a plurality of magnets located thereon, wherein either of the first or second housings is able to rotate with respect to the other housing;
wherein the magnets on either of the first or the second housing are electromagnets and wherein the electromagnets are energised simultaneously when the motor is in use so that the magnetic force of the magnets causes the one housing to rotate with respect to the other housing.

17. A motor according to claim 16 wherein the plurality of magnets are located around a perimeter of the first and/or second housing.

18. A motor according to claim 17 wherein the magnets located on the first housing are of alternating polarities.

19. A motor according to claim 17 wherein the magnets located on the second housing are of alternating polarities.

20. A motor according to claim 17 wherein the magnets located on the first housing are of the same polarity.

21. A motor according to claim 17 wherein the magnets located on the second housing are of the same polarity.

22. A motor according to claim 16 wherein the magnets which are not electromagnets are either permanent magnets or electromagnets.

23. Motor according to claim 16 wherein the first housing has a ratio of radius to width of at least 2:1.

24. A motor according to claim 23 wherein the first housing has a ratio of radius to width of at least 8:1.

25. A motor according to claim 17 wherein the angle of the forces acting between adjacent ones of the magnets on the first housing and the magnets on the second housing does not exceed 25 degrees.

26. A motor according to claim 16 wherein the first housing is able to move with respect to the second and housing and wherein the interior of the first housing is formed into a plurality of propeller blades.

27. A motor according to claim 17 wherein both poles of the magnets on either the first or second housing act simultaneously on the magnets of the other housing.

28. A motor according to claim 16 wherein the motor forms the wheel of a motor vehicle.

29. A motor according to claim 16 wherein the polarity of the electromagnets are alternated by a switching mechanism when the motor is in use.

30. A motor according to claim 16 wherein there are the same number of magnets located on the first and second housings.
